(19) United States
(12) Patent Application Publication
(10) Pub. No.: US 2011/0078086 A1
(43) Pub. Date: Mar. 31, 2011

(54) MAXIMIZING PROCEEDS OF A SHORT SALE

(76) Inventor: Jason W. Byrne, Cherry Hills Village, CO (US)

(21) Appl. No.: 12/893,998

(22) Filed: Sep. 29, 2010

Related U.S. Application Data
(60) Provisional application No. 61/247,435, filed on Sep. 30, 2009.

(51) Int. Cl. G06Q 50/00; G06Q 40/00

(52) U.S. Cl. 705/316

(57) ABSTRACT

Systems and methods of initiating and processing a real estate short sale are disclosed. The methods include the facilitator receiving from a lender or another party associated with a loan a notification identifying a property as a distressed property. The facilitator may secure from the lender an agreement to accept less than 100% of a loan value secured by the property if the property is sold. The facilitator may also confirm that the property and the property owner meet criteria established by a short sale processor.

### CROSS-REFERENCE TO RELATED APPLICATIONS

This nonprovisional patent application claims the priority benefit of provisional U.S. Patent Application Ser. No. 61/247,435, filed on Sep. 30, 2009, titled “Lender-Originated Short Sales,” which is hereby incorporated by reference in its entirety.

### FIELD OF THE INVENTION

The present invention relates generally to real estate processes, and more specifically, but not by way of limitation, to systems and methods for maximizing the proceeds generated by a short sale.

### BACKGROUND

Most homeowners purchase their homes with the aid of a loan secured by the real property. In some instances, the value of the property may decrease to a point at which the aggregate loan amount, including junior loans, exceeds the value of the property. In these instances, the borrower may fail to maintain the payments on the loan or loans on the property, by personal choice or due to economic circumstances.

Traditionally, if a borrower is delinquent on loan payments, and cannot refinance the loan or reach any suitable loan modification terms with the lender, the lender may foreclose on the loan and ultimately become the property owner. Sales of properties owned by lenders are generally undesirable for both the lender and the borrower, as well as for the neighborhood of a subject property. The stigma attached to a sale of property owned by a lender materially reduces the selling price of the property. Properties owned by lenders may not be as well maintained as the other properties in a given neighborhood, thereby decreasing property values for that neighborhood.

One alternative to a foreclosure sale is a short sale. In a short sale, the lender(s) agree to accept less than the full value of the loan or loans secured by the property in order to release the lien(s) on the property. A short sale allows the borrower to rid himself of the loan debt and to transfer title to the property, while also allowing the lender to recoup at least some part of the loan amount without becoming the property owner. However, there are several material drawbacks to short sales for borrowers and lenders. Pre-foreclosure sales are typically much harder than post foreclosure (REO) sales, so the industry has always relied on REO for the vast majority of the volume. The current scale of the problem and the damage that mass amounts of REO will do to our economy, neighborhoods, national property values, and mortgage investors necessitates a more effective and scalable pre-foreclosure solution.

Short sales have historically created a stigma for the borrowers, the sellers of the property. The stigma associated with a short sale decreases the price that can be obtained for the property, thereby reducing the return for both the borrower and the lender. If a distressed property valued at less than the total amount of encumbrances on the property can be sold in a normal retail sale, the amount realized by both the borrower and the lender is maximized. Moreover, the lender is not required to expend time and effort in an area outside his core competency. The lender may be viewed by the borrowers as an assisting party rather than an adversary.

### BRIEF DESCRIPTION OF THE DRAWINGS

FIG. 1 is a flow chart of an exemplary method of maximizing short sale proceeds.

### DETAILED DESCRIPTION

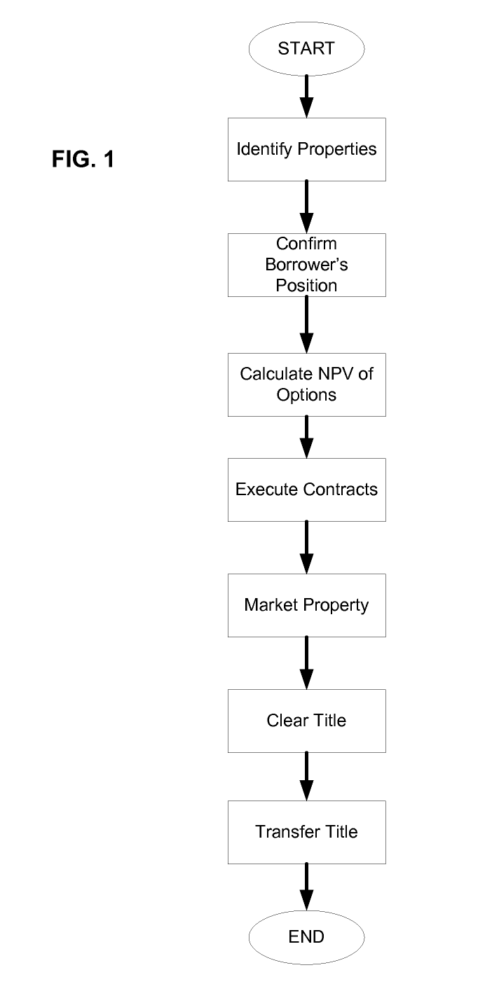

An exemplary short sale method, as depicted in block diagram FIG. 1, may be initiated by a lender or any other party benefitting from a security interest in a property. The method may help to identify to a user one or more properties that are distressed. Identification of distressed properties may be obtained from banks, lenders, investors and/or trustees of various mortgage backed securities, investors and/or trustees of portfolio loan pools, mortgage servicers, special servicers, and loan modification and refinance specialists, among others. In short, anyone who has a role in defaulted mortgages may be a source of identification of a distressed property. For the purposes of this description, a distressed property will be defined as a property subject to at least one secured loan, the loan being in default. The method may focus on residential first mortgages. The user of the method will typically target properties with a loan at least thirty days delinquent, but not yet having undergone a completed foreclosure sale or other method of title transfer.

The borrower may have missed at least one payment due on the loan. The default may be due to the borrower's economic situation or due to falling real estate values which have made the property worth less than the balance of the loan or loans. In the latter situation, the borrower is left with a reduced incentive to make payments on his loans, regardless of his ability to pay.

The user of the system, who may be alternatively referred to in this description as the facilitator, confirms that a property must be sold. The facilitator confirms that the borrower is not in a position to either refinance his loan package or to negotiate a modification of the terms of the loan with the lender.

In many cases the lender/servicer may have attempted a refi and/or loan mod and they have been unsuccessful. The borrower may be experiencing what is known as the “Default Waterfall, ” wherein the borrower is late on payments, has little or no equity, has been turned down for refi, and has been rejected for loan mod. When these events have been confirmed, it may be determined that the property must change hands. Once a property reaches this point the borrower has two options: some form of short sale or foreclosure.

It should be noted that there may be multiple loans on the distressed property, as well as other liens such as tax or improvement liens. If the facilitator confirms that the borrower is not able to in any useful way restructure the debt secured by the property, and is not able to service that debt, then the facilitator may proceed with the pre-foreclosure short sale process.

To provide an accurate estimate of the proceeds of a considered sale, the method utilizes a recovery calculator. The recovery calculator may be an overarching net present value and financial calculator that constantly tracks a plurality of data feeds in order to optimize the recovery realized in the transaction. The recovery calculator may take into account market value, how much is owed on a property, the costs of releasing liens, market feedback, and the underlying structure of the mortgage (whole loan vs. mortgage backed security, presence of guarantor or mortgage insurance, and how the mortgage bond or trust agreement or pooling agreement or servicing agreement deals with servicing, pre-foreclosure sale issues, and foreclosure sale issues). The recovery calculator may be used as a tool to transform “Serial Skirmishing into Parallel Processing.” The transforming aspect of the method may also include advanced jr. lien negotiating techniques that assist in separating the “collateral” value from the “recourse” value.

The facilitator calculates the net present value of the foreclosure option, and compares that to the net present value of the present method, as well as to other potential options. This calculation is performed in order to accurately present to the lender the cost of foreclosure and of other available options, if they were to choose those options. Among the many factors included in the cost analysis are the costs of the foreclosure process, the estimated release cost of various other loans or liens that may be on the property, the current ownership of the property, the legal foreclosure process status of the property, the value of the property in its current, fixed up, or more distressed state determined by automated valuation model and/or broker price opinion and/or appraisal and/or real estate agent and/or actual property listing market feedback, the real estate value trend lines of the neighborhood, the underlying structure and waterfall of the mortgage note or mortgage bond or bond tranche or bond prospectus or bond trust agreement, the carrying costs incurred by the lender if it takes ownership of the property, and the reduced property value of a potentially unoccupied and unmaintained lender-owned property.

The facilitator may illustrate through this procedure how the various methods and their associated net present values may impact the various stakeholders of the first mortgage, such as the mortgage investor, mortgage servicer, mortgage guarantor, and mortgage insurer. The method may give these parties the basis for making a decision as to why they should choose one of the various options presented by the method.

Direct response borrower outreach methodologies and escalation techniques may be utilized in order to persuade borrowers to agree to a pre-foreclosure sale.

If the lender agrees to proceed with the short sale process, the facilitator, the lender, and the borrower may be required to execute multiple agreements. The lender may contract with the facilitator to either accept an amount less than the loan balance following a sale of the property, or for the facilitator to purchase the loan from the lender so that the lender is removed from the process. The borrower may execute a listing agreement with a real estate broker. The broker will typically be a third party, not the facilitator. The broker may be chosen from a pool of brokers certified by the facilitator as qualified in short sale transactions. By requiring a certification process, the facilitator ensures that involved brokers are competent in the procedures required for the sales conducted under the method. The lender may agree with the borrower(s) that no deficiency judgment will be pursued, that the lender will not require an unsecured promissory note, that the borrower will not be reported to credit agencies as late if he agrees to utilize the present method, and even may finance a more affordable property for the borrower(s) and/or pay the borrower a cash incentive in order to incent the borrower into the process or reward the borrower for adhering to the process, leaving the property in good condition, or otherwise cooperating with the process.

Creating a retail—not a distressed—listing, marketing, contracting, and sale transaction may be made possible by the method. Included may be optimizing the property, end buyer, and process for FHA and conforming (Fannie/Freddie) financing—and actually getting the deals and the end buyers loan closed.

Following execution of the listing agreement, the distressed property may be marketed as a standard retail sale, thereby removing the possible stigma associated with a short sale. This may be possible due to the unified and complete structure of the present method and an agreement/relationship with the first lender coupled with an ability to quickly & effectively negotiate with jr lienholders. Negotiations may be supported by valuing the collateral value of the property as zero, and focusing on the recourse value. The recourse value may be valued in the same manner as an unsecured credit card that is 180 days late

As a collateral benefit to the lender, the lender may be positioned as the lender of choice for the new buyer.

Junior liens may have been identified at the outset of the process. The junior lien holders may be contacted to negotiate a release of the junior liens by means of a short payoff agreement and release of lien. As a third party having control over or a contractual relationship with the first loan on the property, the facilitator has significant bargaining power with the junior lien holders, and may be in a position to take actions not typically considered prudent or even possible for the lender.

The status of the junior liens and further pertinent title information may be tracked by the automated program software used in the process.

When the junior liens are extinguished or settled, and the title to the property has been cleared, the sale may be finalized. When a sale is finalized, the borrower avoids the foreclosure process and the associated credit record problems. The lender avoids becoming the property owner and maximizes the recovery amount on the loan.

Automated program software of the present method may track and facilitate all steps. The software platform receives the files from the lender, runs the Recovery Calculator process on the files, the Borrower Outreach, jr lien negotiation, listing, marketing, contracting, and closing processes, and workflows. All workers are constantly working in the platform. All IP, algorithms, and workflows are embedded in the platform. The platform also has all reporting built in.

The automated program software may have distinct log in access portals for the various participants in the process potentially including borrowers, listing real estate agents, the new buyer's real estate agents and new mortgage company and mortgage loan officers, lenders, mortgage insurance companies, mortgage guarantors, mortgage investors, mortgage servicers, title companies, junior lien holders, property preservation companies, asset management companies, automated valuation providers, mortgage backed security trustees, all the various employees and contractors potentially employed by the facilitator, and others.

Some of the above-described functions may be defined by instructions that are stored on storage media (e.g., computer-readable media). The instructions may be retrieved and executed by the processor of the computer on which the system is resident. Some examples of storage media are memory devices, tapes, disks, integrated circuits, and servers. The instructions are operational when executed by the processor to direct the processor to operate in accord with the invention. Those skilled in the art are familiar with instructions, processor(s), and storage media.

It should be noted that any hardware platform suitable for performing the processing described herein is suitable for use with the invention. The terms “computer-readable media” and “storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise an embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, a physical medium with patterns of marks or holes, a RAM, a PROM, an EPROM, an EEPROM, a FLASHEPROM, any other memory chip or cartridge, a carrier wave, or any other medium from which a computer can read.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method of maximizing proceeds in a real estate short sale, the method comprising:
identifying at least one property as a distressed property; securing from the lender an agreement to accept less than 100% of a loan value secured by the property if the property is sold;
confirming that the property and the property owner meet criteria established by a short sale processor;
closing a sale of the distressed property; and
distributing proceeds of the sale.

2. A method of maximizing proceeds in a real estate short sale, the method comprising:
receiving from a lender or another party associated with a loan a notification identifying at least one property as a distressed property;
securing from the lender an agreement to accept less than 100% of a loan value secured by the property if the property is sold;
confirming that the property and the property owner meet criteria established by a short sale processor;
closing a sale of the distressed property; and
distributing proceeds of the sale.
